(19) United States
(12) Patent Application Publication
(10) Pub. No.: US 2016/0066655 A1
(43) Pub. Date: Mar. 10, 2016

(54) Custom Footwear And Custom Footwear Fabrication System and Methods

(71) Applicant: YOOSHU LLC, Littleton, CO (US)

(72) Inventor: Scott D. Goldie, Littleton, CO (US)

(21) Appl. No.: 14/783,764

(22) PCT Filed: May 2, 2014
(86) PCT No.: PCT/US2014/036601

§ 371 Date: Oct. 9, 2015

Related U.S. Application Data
(60) Provisional application No. 61/819,024, filed on May 3, 2013.

(51) Int. Cl. A43D 8/00; A43B 3/12; G05B 15/02; A43D 1/02

(52) U.S. Cl. CPC A43D 8/00; A43D 1/025; A43B 3/128; G05B 15/02

(57) ABSTRACT

Disclosed embodiments include systems for fabricating custom footwear, custom footwear, and blanks useful for creating custom footwear. System embodiments include a processor which controls the fabrication of custom footwear based in part upon contemporaneously received customer input concerning design choices and further based in part upon physical attributes of the customer's feet determined contemporaneously with a foot scanning unit. In some embodiments the entire design and fabrication process is completed at a retail location within the view of the customer.

### CROSS-REFERENCES TO RELATED APPLICATIONS

This application claims the benefit, under 35 U.S.C. §119(e), from co-pending provisional U.S. Patent Application No. 61/819,024 filed May 3, 2013, by Scott Dennis Goldie and titled CUSTOM FOOTWEAR AND CUSTOM FOOTWEAR FABRICATION SYSTEM AND METHODS” which application is hereby incorporated by reference, as if set forth in full in this document, for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

Disclosed embodiments relate generally to custom footwear and systems and methods of fabricating custom footwear.

### BACKGROUND

Sandals and other types of recreational footwear fabricated in part from natural or synthetic rubber, foam rubber, foam polymer or other flexible or elastomeric materials are commonly available and popular footwear products. The foregoing types of sandals are often referred to as “flip-flops.” Some flip-flop or beach-type sandals are fabricated from very inexpensive materials and thus are a short-lived, nearly disposable, consumer product. Other sandals are fabricated from more durable materials and are designed to be more fashionable, functional and long-lasting. Some flip-flop or beach-type sandals are targeted for children and young consumers. Other sandals are targeted toward the adult market. Each of the foregoing categories of footwear are referred to herein collectively as “sandals” or simply “footwear”

Relatively inexpensive and more expensive sandals have certain structural elements in common. In particular, many sandals have a flexible foam rubber or foam polymer base with one or more straps connected to the base in various configurations. Typically, less expensive flip-flop type sandals have a substantially flat or planar upper base surface which supports a user's foot in use. Accordingly, most sandals provide little or no support to the user's arch or other portions of the user's foot which would not normally rest upon a flat surface. Some relatively more expensive sandals have a sculpted upper surface which can provide some arch support, thereby increasing comfort for some users. Sandals which do supply a limited amount of arch support are typically fabricated with generic arch contours which might fit the sole profile of certain users comfortably and which might irritate the soles of other users.

Sandals are typically fabricated in a factory located far from retail sales facilities. Accordingly, sandal purchasers cannot customize the sandals they desire at the point of sale. Furthermore, the style and design choices available to customers are typically limited sandal size, base or strap color and perhaps strap configuration with respect to more expensive brands.

Sandals are also almost exclusively sold through conventional retail outlets such as shoe stores, sporting goods stores, department stores and the like, where there is little or no entertainment associated with the sandal buying experience to motivate prospective customers. The embodiments disclosed herein are directed toward overcoming one or more of the shortcomings noted above.

### BRIEF SUMMARY

The embodiments disclosed herein include systems for fabricating custom footwear, custom footwear, blanks useful for creating custom footwear, various apparatus included within a system for fabricating custom footwear, methods of fabricating custom footwear, methods of selling custom footwear, methods of designing custom footwear and other embodiments.

One particular class of embodiments includes various footwear fabrication systems. The disclosed footwear fabrication systems are configured to fabricate highly customized footwear. In addition, system embodiments include elements which promote and foster an interactive and entertaining retail experience. For example, one disclosed system embodiment features one or more customer input units which provide for the selection of one or more footwear design features by a customer at the point of purchase, before the footwear is created. In addition, the system includes one or more foot scanning units which create a digital representation of one or several physical attributes of the customer's feet. Data concerning the customer's design choices and data from the foot scanning unit are utilized by a computer system or processor to contemporaneously control an on-site footwear forming machine, for example a CNC mill The system therefore causes the footwear forming machine to fabricate footwear incorporating the selected design features and customized to correspond to the scanned physical attributes of the customer's feet while the customer watches and enjoys the fabrication process.

In certain embodiments the footwear is a beach-type sandal with a body fabricated from a flexible material such as foam rubber, rubber, or polymeric foam. System embodiments therefore also include a supply of blanks from which the bodies of custom footwear may be formed. In some embodiments, the supply of footwear blanks is automated and the computer system or processor controlling the footwear forming machine may also control the automated supply of footwear blanks. In other embodiments blanks are manually loaded into the footwear forming machine.

As noted above, system embodiments are configured to produced customized footwear and also configured to provide an entertaining and engaging customer experience. Therefore, in some system embodiments it is useful to have at least the customer input units, foot scanning units and the footwear forming machine located on a single retail pad or within a single retail space. In addition, certain fabrication elements, for example the footwear forming machine and/or any automated footwear blank supply may include transparent safety panels which permit a customer and others to watch while the custom footwear they have designed is machined and otherwise fabricated.

Representative design choices which a customer may make using the customer input units include, but are not limited, to footwear color, footwear sole pattern and footwear strap design. The physical attributes of the customer's feet which may be machined or otherwise formed into the footwear include but are not limited to the customer's actual foot size, the customer's perimeter foot shape, and the three-dimensional contours of the soles of the customer's feet. As used herein, the terms “actual foot size” refers to the actual dimensions of the customer's foot as determined with a foot scanning unit. This is in many cases a different and more precise measurement than the standardized shoe size which would be associated with the customer's actual foot size.

In some embodiments, the blank from which footwear is fabricated is a substantially planar assembly having a select thickness and which is made up of multiple laminations of flexible material. The blank may be provided with a carrying handle. In some embodiments certain laminations, for example the exterior lamination which will correspond to the sole of completed footwear, may be of a different material than upper laminations.

Accordingly, certain embodiments comprise a footwear product fabricated by a system such as described above. The footwear product may include a footwear blank and footwear formed in the footwear blank. The footwear will have upper, lower and side surfaces carved or machined into the blank which incorporate the design choices supplied by the customer and the scanned physical attributes of the customers feet. For example, the footwear carved or formed into the blank may match customer's actual foot size, the customer's actual foot perimeter shape include a contoured upper surface which corresponds to the three-dimensional sole contour of a customer's feet.

The footwear product may also include straps attached to the footwear and extending from upper footwear surfaces to complete a unique sandal customized to the feet of the customer. Furthermore, the sole of the footwear product may be carved or otherwise formed into a tread pattern, a decorative pattern or both, as the footwear is fabricated. The sole pattern may be selected along with other design features using the customer input units before the footwear is fabricated. In certain instances, the sole pattern may be highly individualized and include, for example, the customer's name or a message.

In certain embodiments, the custom footwear created according to the customer's input is delivered to the customer while still positioned within the blank. In these embodiments, any handle included on or through the blank provides a convenient means for the customer to carry their purchase home. The custom footwear may be loosely and removably attached to the blank by small tabs of uncut material, or the custom footwear may be held within the blank by friction.

Alternative embodiments include custom footwear fabricated as described above, after the footwear has been removed from any blank.

Other alternative embodiments include methods of fabricating custom footwear and providing an engaging and entertaining retail experience. Method embodiments feature the processing of customer input regarding footwear design choices plus the processing of scanned physical attributes of the customer's feet to control the automated or semi-automated fabrication of custom footwear on-site during a single retail transaction. Therefore methods include controlling a footwear forming machine with a computer system or processor which receives design input from customer input and also receives dimensional input from a foot scanning unit.

Method embodiments are enhanced by positioning certain elements such as the customer input units, foot scanning unit and footwear forming machine on a single retail pad or at a single retail location. In addition, fabrication elements such as the footwear forming machine may be covered in part with transparent safety panels which allow customers and others to watch as custom footwear is being formed. Thus, the methods result in the creation of highly customized footwear and also provide an engaging and enjoyable retail experience.

Alternative embodiments include computer systems suitable for the control and implementation of the disclosed methods.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic block diagram illustrating a footwear fabricating system, in accordance with various embodiments.

FIG. 2 is a plan view schematic diagram illustrating a footwear fabricating system, in accordance with various embodiments.

FIG. 3 is a perspective view of a footwear fabricating system, in accordance with various embodiments.

FIGS. 4A-4B are a front elevation and side perspective view of a footwear blank in accordance with various embodiments.

FIGS. 5A-5D are views of a footwear blank with footwear formed therein in accordance with various embodiments.

FIGS. 6A-6B are views of a footwear blank with an alternative footwear formed therein in accordance with various embodiments.

FIGS. 7A-7B are views of footwear in accordance with various embodiments.

FIGS. 8A-8B are views of alternative footwear in accordance with various embodiments.

FIG. 9 is a flowchart representation of a method in accordance with various embodiments.

FIG. 10 is a schematic block diagram representation of a computer system in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The embodiments disclosed herein include custom footwear, blanks useful for creating custom footwear, various systems for fabricating custom footwear, various apparatus included within a system for fabricating custom footwear, methods of fabricating custom footwear, methods of selling custom footwear, methods of designing custom footwear and other embodiments. As illustrated in the attached figures, the footwear, blanks, systems and methods may be implemented to create custom sandals. The disclosed embodiments are not however limited to custom sandal fabrication and may be applicable to other footwear or in certain instances to other classes of consumer products.

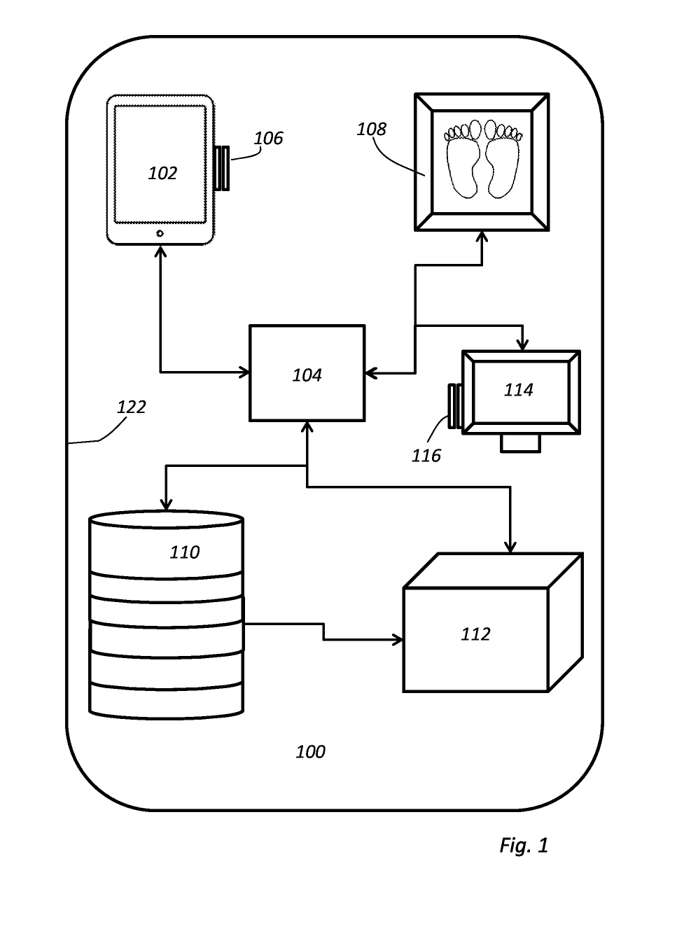

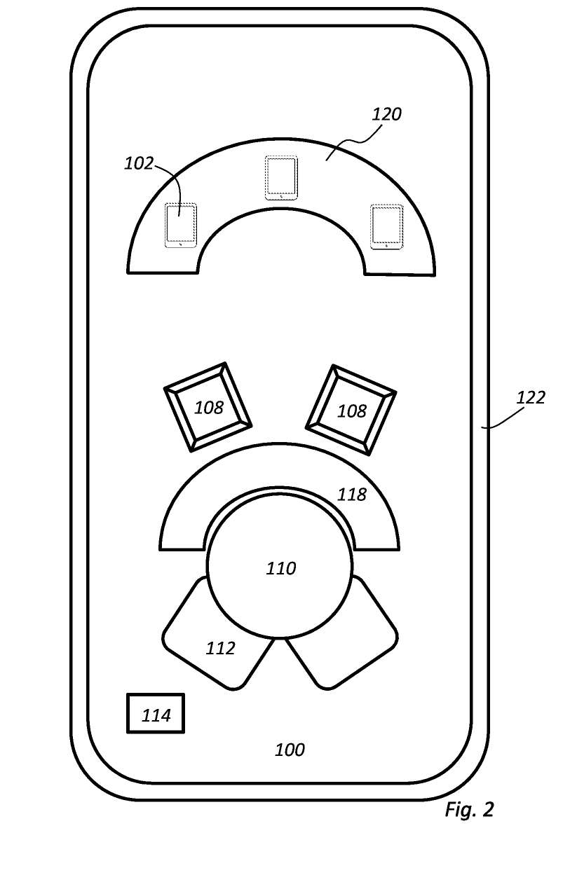

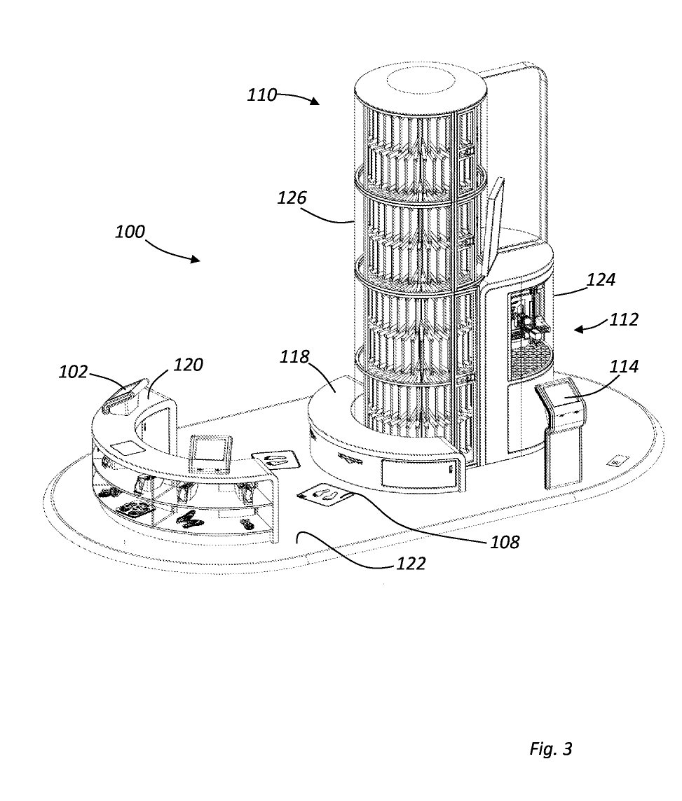

One group of embodiments disclosed herein are systems for custom footwear fabrication. In addition to providing for custom footwear fabrication the disclosed system embodiments incorporate certain functional elements which also provide entertainment to prospective footwear purchasers and therefore motivate purchasers to buy custom footwear products. As illustrated in FIG. 1, FIG. 2 and FIG. 3 system embodiments include several distinct elements which work together to create unique custom footwear while providing entertainment to prospective customers.

For example, as schematically illustrated in FIG. 1, a system 100 may include one or more customer input units 102 (referred to below in the singular, although any number of customer input units 102 may be provided) which provide for customer selection of one or more footwear design features prior to the fabrication and purchase of a footwear product. The customer input unit 102 will typically include one or more computer interfaces which visually or graphically present various design choices to the customer as described in significantly greater detail below. Therefore the customer input unit 102 may be implemented with any type of computer or digital interface, including but not limited to a tablet computer, a personal computer, a dedicated computer terminal, a smart phone or similar apparatus possessing at least a monitor or screen. In certain embodiments the monitor or screen of the customer input unit may be implemented with a touchscreen configured to receive and process direct tactile input from the customer. In other implementations the customer input unit 102 may receive input from conventional keyboards, computer mouse or voice detection technologies.

In some embodiments, the customer input unit 102 may be a standalone computing device having a processor, for example the tablet computer customer input unit 102 of FIG. 1 and FIG. 2. In other embodiments, the customer input unit 102 may be implemented with a monitor or terminal such as the customer input unit 102 of FIG. 3 which communicates with a separate processor or computer system.

In any embodiment, the customer input unit 102 is placed in digital communication with at least a computer system having at least one processor 104. Communication between the customer input unit 102 and processor 104 may be accomplished with any means including but not limited to a local area network or wide area network. Alternatively, in certain embodiments, the customer input unit 102 and processor 104 may be housed within the same enclosure or otherwise be part of the same computing system.

In all embodiments, the customer input unit 102 may be utilized by a customer to select footwear for purchase and make certain design choices with respect to the selected footwear, prior to the fabrication of the selected footwear. For example, a customer may be able to select features including but not limited to footwear color, footwear sole pattern(s) or footwear strap design or material using the customer input unit 102. Furthermore, as illustrated in FIG. 1, the customer input unit 102 may also include a credit card reading device 106 or other point-of-sale apparatus permitting the customer to purchase the customized footwear as part of the design experience. In other embodiments, as described below, point-of-sale functionality is provided at other locations within the system 100.

The system 100 will also include one or more foot scanning units 108. Each foot scanning unit 108 includes optical, mechanical and digital elements configured to scan, measure and digitize certain aspects of the customer's feet. Therefore, a foot scanning unit 108 will typically be positioned at ground level and have an upper glass, acrylic or other transparent surface upon which a customer can place the soles of their bare feet prior to the fabrication of custom footwear. When the customer has placed their feet on the scanner, optical and mechanical apparatus below the transparent surface are utilized to perform a foot scan. The foot scan is then rendered as a digital representation of certain physical attributes of the customer's feet. The scanned attributes can include, but are not limited to, actual foot size and foot perimeter shape (determined in a plane substantially parallel to the plane of the transparent surface of the foot scanning unit 108). As used herein, the terms “actual foot size” refers to the actual dimensions of the customer's foot as determined with a foot scanning unit. This is, in many cases, a different and more precise measurement than the standardized shoe size which might be associated with the customer's actual foot size.

In addition the foot scanning unit 108 will stereoscopically determine and store a three-dimensional map of the contours of the sole, heel and other portions of the customer's feet, which data is referred to herein as a “sole contour”.

As schematically illustrated in FIG. 1, the foot scanning unit 108 is also in digital communication with the computer system or processor 104. Accordingly, the processor receives data from at least two sources including but not limited to data representative of the customer's footwear design choices received from the customer input unit 102 and data representative of the scanned attributes of the customer's feet received from the foot scanning unit 108. These data sets are received by the computer system or processor 104 prior to the fabrication of custom footwear for the customer.

The system 100 also includes a supply of footwear blanks 110. In certain embodiments the supply of footwear blanks 110 is simply a static supply of footwear blanks which are accessible to a system operator who manually feeds a footwear blank corresponding to the customer's design choices into a footwear forming machine 112 for further processing, as described below. In other embodiments, such as illustrated in the perspective view of FIG. 3, the supply of footwear blanks 110 is implemented with an automated or fully robotic supply of blanks in digital communication with the computer system or processor 104. In a system 100 utilizing an automated supply of footwear blanks 110, the processor 104 may cause robotic elements or material transport mechanisms within the supply 110 to automatically select and transport a footwear blank corresponding to the customer's design choices to the footwear forming machine 112 for further processing.

As noted above, the system 100 will include a footwear forming machine 112 in digital communication with the computer system or processor 104. Thus, the processor 104 is configured to control the operation of the footwear forming machine 112 to cause the footwear forming machine to fabricate footwear incorporating the design choices of the customer. In addition, the computer system or processor 104 is configured to cause the footwear forming machine 112 to customize the footwear to correspond to one or more of the scanned attributes of the customer's feet. Thus, the footwear forming machine 112 is controlled to form footwear from a selected footwear blank which incorporates the customer's design choices and is also sized to the actual size of the customer's feet, has a perimeter shape corresponding to the perimeter shape of the customer's feet and/or has upper surfaces which correspond to the sole contours previously obtained from the customer's left and right feet. In certain embodiments the footwear forming machine may perform all of the foregoing operations.

Typically, the footwear forming machine 112 will be implemented with a CNC milling machine under the control of the computer system or processor 104. In alternative embodiments, the footwear forming machine may include heat and/or vacuum forming elements, molding elements or other material forming subsystems. In an embodiment where the footwear forming machine 112 is implemented with a CNC milling machine, it may be advantageous to provide the CNC milling machine with multiple milling heads so that multiple surfaces of the footwear blank, for instance the top and bottom surfaces, may be milled simultaneously.

The system 100 may optionally include additional input and control modules in communication with the processor 104, for example the operator terminal 114 illustrated in FIGS. 1-3. The operator terminal 114 may be used by a system operator to control system elements not directly controlled through the customer input unit 102, to troubleshoot the system, perform routine maintenance, power system elements on or off, or to process payments, for example with credit card reader 116 and for other purposes.

In addition a system 100 may include certain structures providing for a more convenient and engaging customer experience. For example, the system may include one or more benches 118 providing a convenient place for a customer to sit during the foot scanning process. Similarly, the system may include counter and storage space 120 which supports the customer input units 102 or other structures at convenient heights. Other elements may include a workspace and storage for the system operator. Utilizing the workspace, the system operator may complete certain fabrication steps or processes which are not fully completed in the footwear forming machine 112, for example attaching straps to customized footwear after machining steps have been performed.

As illustrated in FIGS. 1-3 the system 100 may also include a single retail pad 122, floor or other physical structure including but not limited to one or more full or partial height walls defining an integrated retail space where some of the foregoing elements are located. As noted above, the system 100 provides for both the fabrication of custom footwear and the entertainment of customers and prospective customers. Therefore, certain elements including the customer input unit 102, foot scanner 108 and footwear forming machine 112 are advantageously located on a single retail pad 122 or in an integrated retail space defined by walls, partial walls or another enclosure. Thus, the customer is encouraged to become engaged with the footwear design and fabrication process and, as described below, watch their footwear as it is created.

Other system elements, in particular the computer system or processor 104 may be remotely located if desired, since the processor 104 does not necessarily enhance the customer experience or provide entertainment value. Thus, it should be noted that the processor 104 may be located anywhere in digital communication with other system elements through a local or wide area network. Alternatively, the processor may be located remotely, in the cloud, or otherwise positioned, provided the processor is in communication with other system elements as described above. Furthermore, the processor 104 may be implemented with multiple physical processors, computers or specific computing apparatus.

Customer participation in the fabrication process is further encouraged in certain embodiments by providing at least the footwear forming machine 112 and potentially the supply of footwear blanks 110 or other system elements with one or more transparent safety panels which permit a customer to safely view certain fabrication processes, including but not limited to, the milling of a footwear blank within the footwear forming machine 112 or the robotic selection and transportation of a footwear blank from the footwear blank supply 110. See, for example, the transparent safety panels 124 and 126 of FIG. 3.

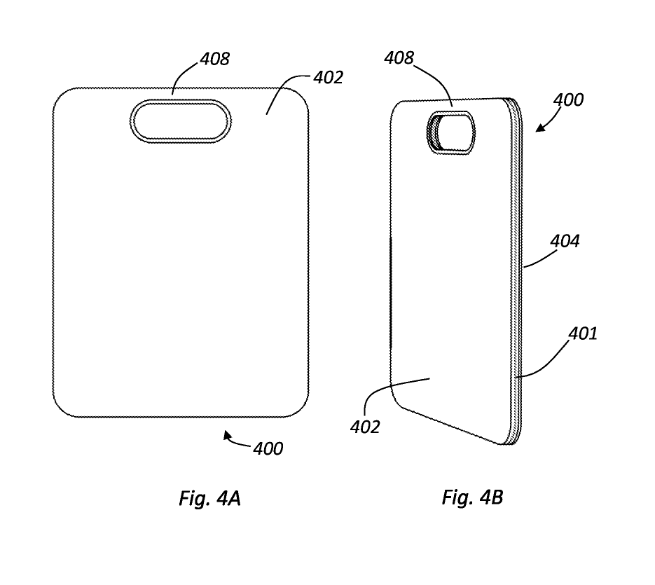

As described in detail above, in one class of embodiments, the system 100 provides for the fabrication of custom footwear from a footwear blank. A representative footwear blank 400 is illustrated in FIGS. 4A-4B. It is important to note that a footwear blank may be formed have any suitable size, shape or thickness. The illustrated footwear blank 400 is a representative example of one possible footwear blank not intended to be an exclusive or limiting example. The illustrated footwear blank 400 is a substantially planar assembly having a selected thickness and formed from multiple laminations 401 of a flexible material. The selected thickness and number of laminations 401 can be varied. In an alternative embodiment, the blank 400 may be fabricated from a single sheet of flexible material with no laminations. As illustrated in FIGS. 4-6 the footwear blank 400 may have a top surface 402 which will correspond with the upper surface of the footwear after footwear has been fabricated from the blank 400. Similarly, the footwear blank 400 may have a bottom surface 404 which corresponds with the footwear sole after fabrication.

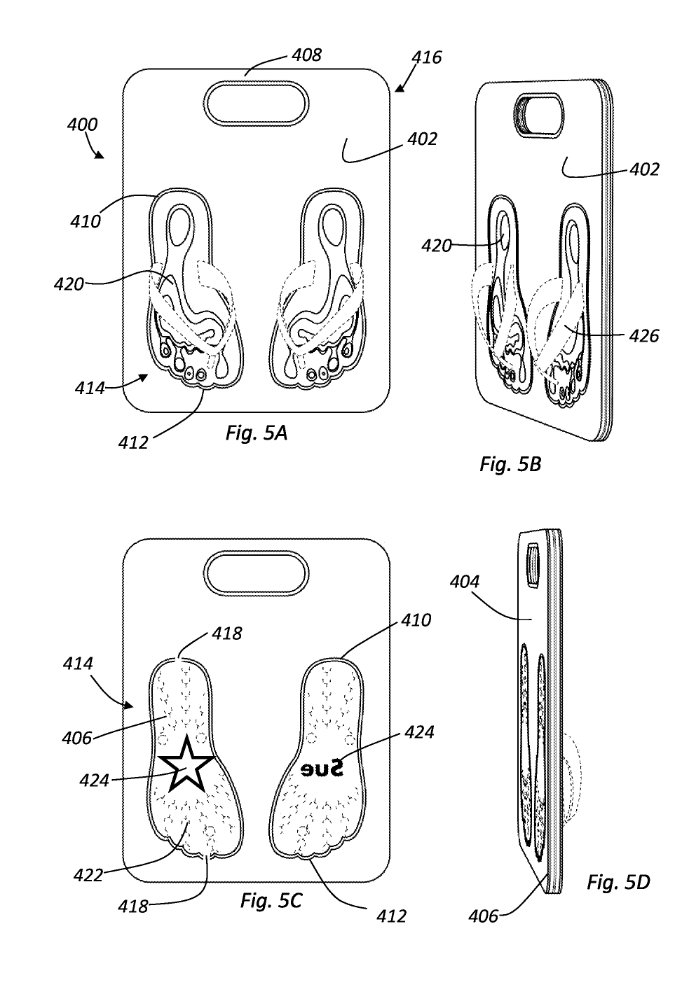

A footwear blank 400 may be fabricated from any suitable material or combinations of suitable materials having an acceptable level of flexibility and hardness. For example, in certain embodiments a footwear blank 400 may be fabricated from a polymeric foam, natural or synthetic foam rubber materials, rubber, cork, ethylene vinyl acetate foam or combinations of similar materials. In certain embodiments featuring a laminated blank 400, certain laminations may be fabricated from different materials than other laminations. For example the exterior lamination 406 (See FIGS. 5C and 5D) corresponding to the bottom surface 404 may be fabricated from a material which provides slip and wear resistance or which is more suited than the upper laminations to tread or design machining. One material which is particularly well suited to an exterior lamination 406 corresponding to the bottom surface 404 is sheet material sintered from cork and rubber granules.

The footwear blank 400 may include adjacent laminations of contrasting colors which provide a visual contour map showing the sole contour machined on the upper surface of finished footwear, in embodiments where the sole contour is machined through at least a portion of multiple laminations. In addition, the footwear blank 400 may be implemented with somewhat harder materials or laminations than is typical with flip-flop type sandals since footwear prepared with the disclosed systems will closely fit the sole contour of a customer and therefore require significantly less break in before the sandals are comfortable.

As shown in FIGS. 4 and 5 the blank 400 may include a handle 408 machined, carved or otherwise associated with the blank 400. The handle 408 can be formed in the blank 400 as part of the blank fabrication process. Alternatively, the handle 408 can be carved into the blank in the footwear forming machine 112 as part of the footwear fabrication process.

As noted above, the computer system or processor 104 controls the footwear forming machine 112 causing the footwear forming machine 112 to form customized footwear within the blank corresponding to at least one scanned attribute of the customer's feet. Foot attributes include but are not limited to actual foot size, foot perimeter shape, and three-dimensional sole contour. Therefore, the footwear forming machine 112 performs some or all of the processes described below to create custom footwear. The particular order of the following processes may be varied as desired to provide for efficient machining.

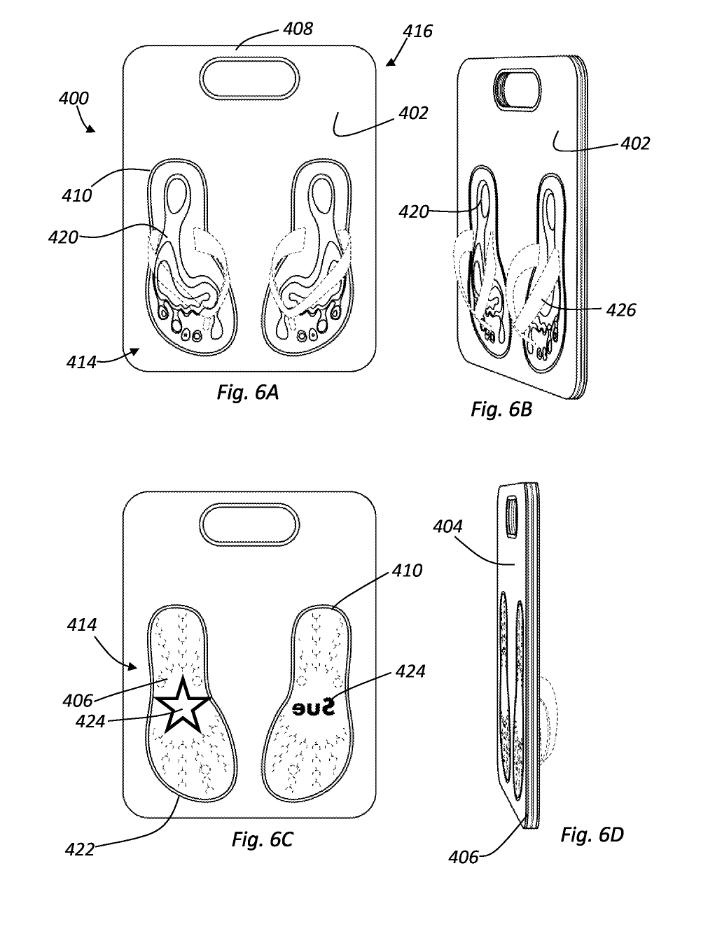

One machining step includes the formation of a footwear edge 410 corresponding to a generic foot shape of various sizes or, in alternative embodiments corresponding, at least in part, to the actual scanned perimeter shape of the customer's feet. Therefore, in certain embodiments the footwear edge 410 will closely match the scanned perimeter shape of the customer's feet including, as illustrated in FIGS. 5A-5D perimeter indentations 412 matching the size and position of the customer's toes. In other embodiments, as illustrated in FIGS. 6A-6D the footwear edge 410 will only generally match the scanned perimeter shape of the customer's feet providing a more generic foot shape with a rounded toe end, and a length and possibly a width machine to match the customer's actual foot size.

Advantageously, the footwear edge 110, when completed in the footwear forming machine 112, may define an incomplete perimeter between the footwear 414 formed in the blank 400 and an exterior portion 416 of the blank 400. As shown in FIG. 5C, an incomplete footwear edge 410 causes one or more select portions or segments 418 of the blank material to remain intact between the footwear 414 and the exterior portion 416 of the blank 400 after the initial sandal fabrication process is completed. This connection between the footwear and the exterior portion 416 permits the customer to conveniently carry their customized footwear home using the handle 408. When the customer desires to remove the footwear 414 from the blank 400, the connecting segments 418 may be cut with a knife or scissors or simply pulled apart by the customer permitting the footwear 414 to be removed from the blank 400.

The footwear forming machine 112 may also carve or machine a three-dimensional sole contour 420 into one or more upper laminations of the blank 400. As noted above, the sole contour 420 of the footwear 414 is carved to match the sole contour of the customer's feet as determined with the foot scanning unit 108. The three-dimensional sole contour 420 significantly enhances customer comfort since the upper surface of the custom sandals match the contours of the customer's feet. In addition, as shown in FIGS. 5A and 6A the three-dimensional sole contour is readily visible to the customer in embodiments where contrasting laminations are used to fabricate the footwear blank 400.

The three-dimensional sole contour 420 can be relatively complex, as shown in FIGS. 5 and 6 and formed to include indentations for toes and heel, raised areas for the customer's arch and raised areas between the ends of the toes and the pad of the customer's foot. The complexity of the three-dimensional sole contour 420 is limited only by the resolution of the foot scanning unit 108 and the precision of the footwear forming machine 112.

The footwear forming machine 112 may also machine the bottom surface of the footwear, corresponding in some embodiments to the exterior lamination 406. In particular, a tread pattern 422 may be formed in the bottom surface of the footwear 414. Alternatively, or in addition to a tread pattern 422, one or more decorative patterns 424 may be formed in the bottom surface of the footwear 414. As illustrated in FIG. 5C, the decorative pattern 424 may be any type of graphic design, which is represented by a star in the figure as a non-limiting example. In some embodiments, the decorative pattern 424 may be the customer's name or another words or message. In some embodiments, as also illustrated in FIG. 5C, the decorative pattern 424 may be a name or word formed in a mirror-reverse fashion so that the decorative pattern 424 imprints a legible name or message when the customer walks across wet sand. Each of the tread pattern 422 and decorative pattern 424 may be selected or designed by the customer using templates, samples, choices, or free-form design options presented to the customer at the customer input unit 102 as part of the footwear design process.

Although the formation of a perimeter edge 410, sole contour 420 and bottom tread pattern 422 or decorative pattern 424 are described above as discrete steps, it may be possible in certain embodiments to combine some or all of the fabrication or machining steps or perform fabrication or machining steps simultaneously. The specific machining and fabrication step order utilized in any system 100 will depend upon the nature and capabilities of the footwear forming machine 112.

As shown in FIGS. 5 and 6, the footwear 414 will typically include a strap 426. The strap 426 may be provided in any suitable configuration and fabricated from any suitable material. The configuration, color, material choice or other strap attributes may be selected by the customer at the customer input unit 102 as part of the footwear design process. In certain instances, for example if the footwear forming machine 112 is a CNC mill, it would be difficult to automatically attach the strap 426 to the footwear 414. Accordingly, in some embodiments the strap 426 is selected based upon user input and attached to the footwear 414 after the blank 400 has been removed from the footwear forming machine 112. The strap 426 can be attached while the footwear is still attached to the blank 400 or after the footwear has been removed from the blank. In addition, the strap 426 can be attached by a system operator or by the customer. Typically, any necessary slots, holes or other structures required to facilitate the attachment of the strap can be machined in the footwear 414 during processing in the footwear forming machine 112.

Although FIGS. 5-6 illustrate one pair of footwear formed in each blank, this configuration is not limiting. A larger blank can be utilized to form multiple pairs of footwear if desired. Alternatively, a blank suitable for the formation of one pair of adult-sized footwear might be divided in the footwear forming machine 112 and utilized to form two pair of child-sized footwear. In certain embodiments, the footwear forming machine 112 may also be used to carve or form supplemental or bonus products in portions of the blank not used to form custom footwear. For example the exterior portion of the blank 416 may be carved or machined to form promotional trinkets, beach toys, key chains, figurines or other small items which enhance the overall customer experience.

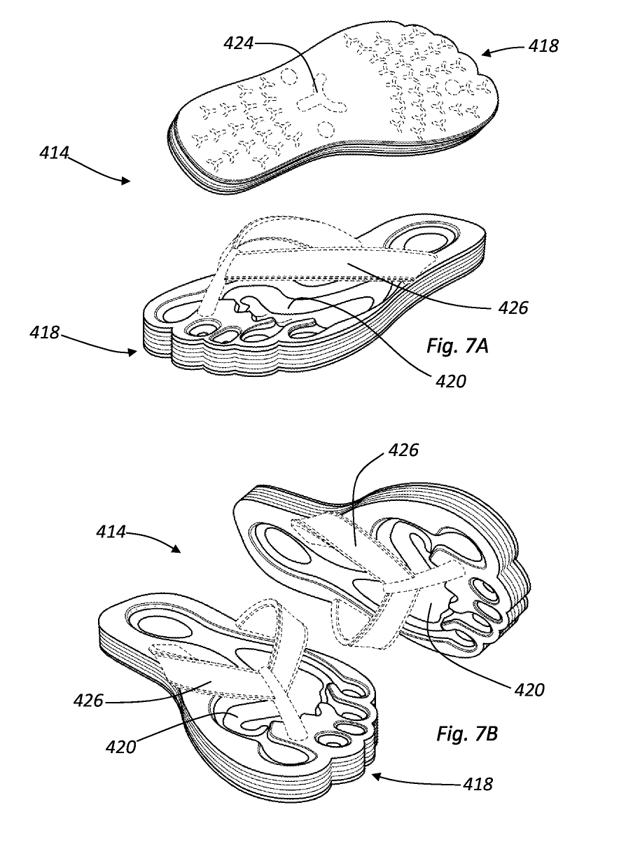

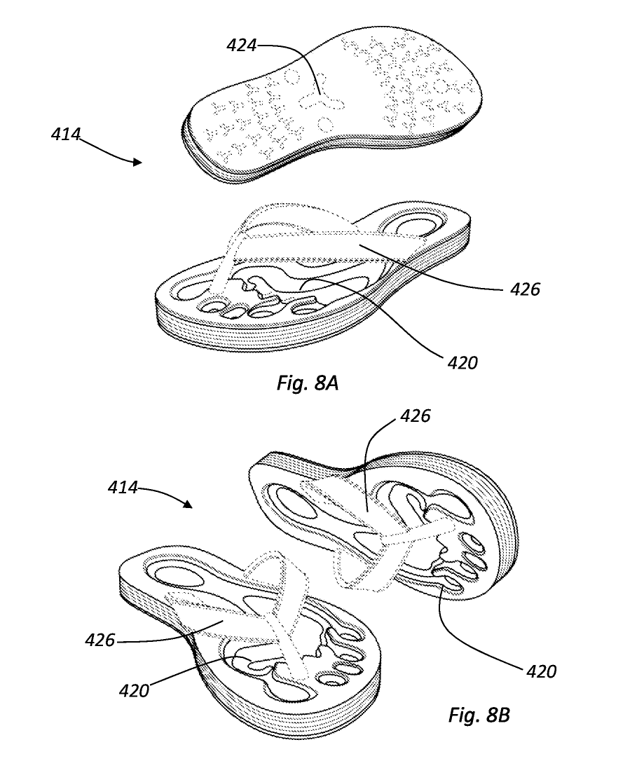

Alternative embodiments disclosed herein include customized footwear 414 prepared using a system embodiment 100 as described above. Therefore, the customize footwear will have the unique customized features as noted above. Representative footwear 414 are illustrated in FIGS. 7A-7B and 8A-8B.

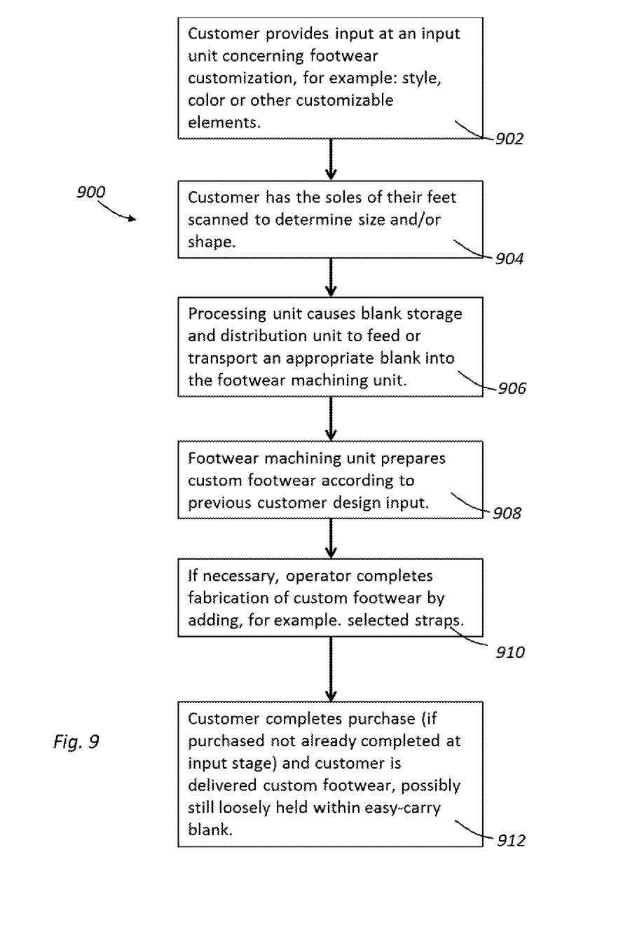

Alternative embodiments include methods of fabricating custom footwear and providing an interactive and entertaining customer experience. As illustrated in FIG. 9 one representative method includes the steps of receiving customer input at a customer input unit 102 regarding the selection of one or more design features which the customer desires to incorporate into custom footwear they intend to purchase (step 902). After any required customer input steps are completed, a system operator, or the customer, may obtain a digital representation of at least one scanned attribute of the customer's feet using a foot scanning unit 108 (step 904). The scanned attribute of the customer's feet may include but is not limited to the customer's actual foot size, foot perimeter shape and three-dimensional foot sole contour.

Data representing the customer's footwear design choices and scanned foot attributes are conveyed from the customer input unit 102 and foot scanning unit 108 to a computer system or processor 104 which control certain automated footwear fabrication steps. For example, in certain embodiments the processor 104 may cause an automated supply of footwear blanks 110 to supply an appropriate blank 400 to a footwear forming machine 112 (step 906). Alternatively, a system operator may manually select an appropriate footwear blank 400 and load same into the footwear forming machine 112.

The processor 104 also causes the footwear forming machine 112 to carve, machine or otherwise form the blank into footwear 414 having some or all of the attributes described in detail above (step 908). For example, the footwear forming machine may carve a perimeter edge defining the footwear 414 within the footwear blank 400, carve, machine or mold a customer selected pattern on a bottom surface of the footwear 414 and carve a three-dimensional sole contour into the upper surface of the footwear 414 which matches the sole contour of the customer's foot as determined in step 904. In addition, the footwear forming machine may carve, drill or otherwise form any necessary openings, slots or other structures required to attach a selected strap to the footwear 414.

Upon completion of all steps required within the footwear forming machine 112, and operator (which may be a robotic or human operator) may remove the carved footwear blank 400 from the footwear forming machine and add straps or other structures as necessary to complete the custom footwear (step 910). The customer may then complete and pay for the purchase if the purchase has not already been completed at step 902 above. In certain embodiments payment may be accepted at the customer input unit 102 or a separate operator terminal 114 (step 912).

Various steps of the footwear design and fabrication process are advantageously completed on a single retail pad 122 or at a single retail location in full view of the customer. In addition certain processing machinery including but not limited to the footwear forming machine 112 may incorporate transparent safety panels encouraging the customer and others to watch and enjoy the fabrication process. Thus the method embodiments facilitate a fun and engaging retail experience in addition to providing customized footwear.

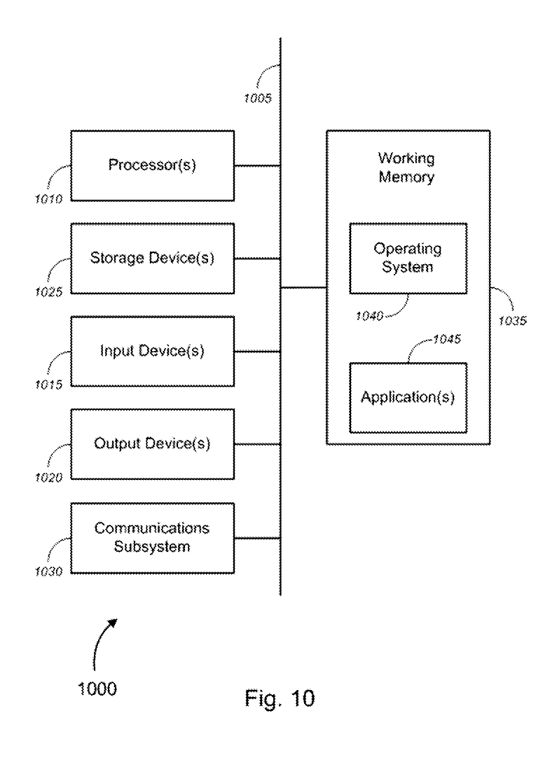

Certain of the foregoing method embodiments are implemented with logic executed by a processor 104. Those skilled in the art will recognize that the processor 104 operates in association with other elements of a computer system. FIG. 10 provides a schematic illustration of one embodiment of a computer system 1000 that can perform the methods provided by various embodiments, as described herein, and/or can function for example, to receive data from a customer input unit 102, foot scanning unit 108 or to control footwear forming machine 112 or automated footwear blank supply 110 as described above. It should be noted that FIG. 10 is meant only to provide a generalized illustration of various components, of which one or more (or none) of each may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a mouse, a keyboard and/or the like; and one or more output devices 1020, which can include without limitation a display device, a printer and/or the like.

The computer system 1000 may further include (and/or be in communication with) one or more storage devices 1025, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 1030 may permit data to be exchanged with a network (such as the network described below, to name one example), with other computer systems, and/or with any other devices described herein. In many embodiments, the computer system 1000 will further comprise a working memory 1035, which can include a RAM or ROM device, as described above.

The computer system 1000 also may comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 1025 described above. In some cases, the storage medium might be incorporated within a computer system, such as the system 1000. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer readable medium, such as one or more of the storage device(s) 1025. Merely by way of example, execution of the sequences of instructions contained in the working memory 1035 might cause the processor(s) 1010 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 1000, various computer readable media might be involved in providing instructions/code to processor(s) 1010 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 1025. Volatile media includes, without limitation, dynamic memory, such as the working memory 1035. Transmission media includes, without limitation, coaxial cables, copper wire and fiber optics, including the wires that comprise the bus 1005, as well as the various components of the communication subsystem 1030 (and/or the media by which the communications subsystem 1030 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000. These signals, which might be in the form of electromagnetic signals, acoustic signals, optical signals and/or the like, are all examples of carrier waves on which instructions can be encoded, in accordance with various embodiments of the invention.

The communications subsystem 1030 (and/or components thereof) generally will receive the signals, and the bus 1005 then might carry the signals (and/or the data, instructions, etc. carried by the signals) to the working memory 1035, from which the processor(s) 1005 retrieves and executes the instructions. The instructions received by the working memory 1035 may optionally be stored on a storage device 1025 either before or after execution by the processor(s) 1010.

In certain embodiments, the customer input unit 102 comprises a user interface 1100. The user interface 1100 allows users to interact with the computer system 1000. A variety of user interfaces may be provided in accordance with various embodiments, including without limitation graphical user interfaces that display, for a customer or system operator, display screens for providing information to the customer and/or receiving user input from a customer.

Certain methods disclosed herein further comprises providing a user interface to allow interaction between a customer and the computer system 1000 or processor 104. Typically, the user interface is provided on the customer input unit 102. For example, the user interface can be used to output information for a customer, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc.

In many cases, providing a user interface will comprise providing one or more display screens on a customer input unit 102, each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by processor 104 in accordance with the described embodiments, it should be appreciated that the choice of user interface elements for a particular purpose is typically implementation-dependent and/or discretionary. Hence, the described user interface elements employed by any display screens described herein should be considered exemplary in nature, and the reader should appreciate that other user interface elements could be substituted within the scope of various embodiments.

As noted above, in an aspect of certain embodiments, the user interface provides interaction between a customer and the processor 104 and/or computer system 1000. Hence, when this document describes procedures for displaying (or otherwise providing) information to a user, or to receiving input from a user, the user interface may be the vehicle for the exchange of such input/output.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A footwear fabrication system comprising:
one or more customer input units providing for the selection of at least one footwear design feature by a customer;
a foot scanning unit providing a digital representation of at least one physical attribute of the customer's feet;
a supply of footwear blanks;
a footwear forming machine; and
a processor receiving input from the customer input unit and the foot scanning unit, the processor being configured to control the footwear forming machine and cause the footwear forming machine to fabricate footwear incorporating the at least one footwear design feature selected by the customer and the processor being further configured to cause the footwear forming machine to customize the footwear to correspond to the scanned physical attribute of the customer's feet.

2. The footwear fabrication system of claim 1 wherein the supply of footwear blanks comprises an automated supply of footwear blanks, and wherein the processor is configured to control the automated supply of footwear blanks and cause the automated supply of footwear blanks to supply a selected blank to the footwear forming machine.

3-4. (canceled)

5. The footwear fabrication system of claim 2 further comprising a retail pad, wherein the one or more customer input units, the foot scanning unit, the footwear forming machine, the automated supply of footwear blanks and the processor are each located on the retail pad.

6. (canceled)

7. The footwear fabrication system of claim 2 wherein the footwear forming machine and the automated supply footwear blanks each comprise at least one transparent safety panel providing for the customer to view a select portion of the process of transporting a blank from the automated supply of footwear blanks to the footwear forming machine and further to view a select portion of the footwear forming process.

8. The footwear fabrication system of claim 1 wherein the footwear forming machine comprises a CNC mill being digitally controlled by the processor.

9. The footwear fabrication system of claim 8 wherein the CNC mill comprises more than one milling head and further is configured to simultaneously mill two surfaces of a footwear blank.

10. The footwear fabrication system of claim 1 wherein the one or more customer input units provide for the selection of at least one of footwear color, footwear sole pattern and footwear strap design.

11. (canceled)

12. The footwear fabrication system of claim 1 wherein the foot scanning unit provides a digital representation of the customer's actual foot size, the customer's foot perimeter shape and the customer's three-dimensional sole contour to the processor.

13. The footwear fabrication system of claim 12 wherein the customer's foot perimeter shape comprises a perimeter defined around portions of the customer's individual toes.

14. The footwear fabrication system of claim 1 wherein the supply of footwear blanks comprises a plurality of individual blanks with each blank comprising a substantially planar assembly having a select thickness comprised of multiple laminations of a flexible material.

15. The footwear fabrication system of claim 14 wherein each substantially planar footwear blank assembly comprises a carrying handle formed through the multiple laminations of flexible material.

16. The footwear fabrication system of claim 14 wherein each substantially planar footwear blank assembly comprises an exterior lamination corresponding to the sole of a completed article of footwear which lamination comprises a flexible material having a different composition than the remaining laminations of the footwear blank.

17-37. (canceled)

38. A method of fabricating footwear comprising:
receiving a selection of at least one footwear design feature from a customer with a customer input unit;
obtaining a digital representation of at least one scanned physical attribute of the customer's feet with a foot scanning unit;
providing a footwear blank;
loading the footwear blank into a footwear forming machine;
controlling the footwear forming machine with a processor receiving input from the customer input unit and the foot scanning unit, to cause the footwear forming machine to fabricate footwear incorporating the at least one footwear design feature selected by the customer; and
controlling the footwear forming machine with the processor to cause the footwear forming machine to customize the footwear to correspond to the scanned physical attribute of the customer's feet.

39. The method of claim 38 further comprising:
providing an automated supply of footwear blanks; and
controlling the automated supply footwear blanks with the processor to cause the automated supply of footwear blanks to supply a selected blank to the footwear forming machine.

40. The method of claim 39 further comprising
providing a retail pad; and
locating each of the one or more customer input units, the foot scanning unit, the footwear forming machine, the automated supply of footwear blanks and the processor on the retail pad.

41. The method of claim 38 further comprising:
providing the footwear forming machine with at least one transparent safety panel; and
viewing a select portion of the footwear forming process.

42. The method of claim 38 wherein the footwear forming machine comprises a CNC mill having more than one milling head and the method further comprises simultaneously milling two surfaces of a selected footwear blank.

43. The method of claim 38 further comprising receiving a selection of at least one of footwear color, footwear sole pattern and footwear strap design from a customer with the customer input unit.

44. The method of claim 38 further comprising obtaining a digital representation of the customer's foot size, the customer's foot perimeter shape, wherein the customer's foot perimeter shape comprises a perimeter defined around portions of the customer's individual toes, and the customer's three dimensional sole contour with the foot scanning unit.

45. (canceled)

46. The method of claim 38 wherein each footwear blank comprises a carrying handle formed through the multiple laminations of flexible material.

47-51. (canceled)
